(19) United States
(12) Patent Application Publication
(10) Pub. No.: US 2020/0217394 A1
(43) Pub. Date: Jul. 9, 2020

(54) POWER TRANSMISSION DEVICE

(71) Applicant: EXEDY Corporation, Osaka (JP)

(72) Inventors: Yuki Kawahara, Osaka (JP); Katsunari Kato, Osaka (JP)

(73) Assignee: EXEDY Corporation, Osaka (JP)

(21) Appl. No.: 16/688,196

(22) Filed: Nov. 19, 2019

(30) Foreign Application Priority Data
Jan. 9, 2019 (JP) 2019-001868

(51) Int. Cl. F16F 15/03; F16F 15/137

(52) U.S. Cl. CPC F16F 15/03; F16F 15/137

(57) ABSTRACT

A power transmission device disposed in a path from a drive source to a wheel in a vehicle is disclosed. The power transmission device includes an input-side rotary member, an output-side rotary member, and a magnetic damper mechanism. A torque is inputted from the drive source to the input-side rotary member. The output-side rotary member is disposed to be rotatable relative to the input-side rotary member. The magnetic damper mechanism is configured to elastically couple the input-side rotary member and the output-side rotary member in a rotational direction by a magnetic force of attraction. The magnetic damper mechanism has a variable stiffness.

### CROSS-REFERENCE TO RELATED APPLICATIONS

This application claims priority to Japanese Patent Application No. 2019-001868, filed Jan. 9, 2019. The contents of that application are incorporated by reference herein in their entirety.

### TECHNICAL FIELD

The present invention relates to a power transmission device, particularly to a power transmission device disposed in a path from a drive source to a wheel in a vehicle.

### BACKGROUND ART

For example, in automobiles, a damper device (e.g., Japan Laid-open Patent Application Publication No. 2018-150957) is installed, as a power transmission device, between an engine and a transmission. The damper device includes an input-side plate, to which a torque transmitted from a drive source is inputted, and an output-side member coupled to an input shaft of the transmission. The input-side plate and the output-side member are rotatable relative to each other in a predetermined angular range, and are elastically coupled in a rotational direction by a plurality of torsion springs.

Generally in order to inhibit noise (e.g., muffled sound) and vibration, it is desirable in the damper device to obtain a torsional characteristic with low stiffness or reduce a hysteresis torque generated in a torsional characteristic.

However, obtaining such a torsional characteristic with low stiffness could result in occurrence of malfunctioning in hybrid vehicles or FR (front engine rear wheel drive) vehicles, because a high-order resonance point occurs in a normal engine rotational speed range due to a large number of drive-train contacts provided in those vehicles.

Additionally, when the damper device is directly connected to the engine in the hybrid vehicles and so forth, it is concerned that a drive system is damaged by a transient torque, because frequency passes through resonance points of engine start and stop in an actuation range of the damper device. To present this, it can be assumed to increase a hysteresis torque. In this assumption, however, noise and vibration cannot be inhibited.

### BRIEF SUMMARY

It is an object of the present invention to obtain a power transmission device configured to be capable of realizing inhibition of noise and vibration in occurrence of a high-order resonance point, and simultaneously, realizing reduction in damage to be caused by a transient torque with respect to a drive system.

(1) A power transmission device according to the present invention is disposed in a path from a drive source to a wheel in a vehicle. The present power transmission device includes an input-side rotary member, an output-side rotary member and a magnetic damper mechanism. The input-side rotary member is a member to which a torque is inputted from the drive source. The output-side rotary member is disposed to be rotatable relative to the input-side rotary member. The magnetic damper mechanism elastically couples the input-side rotary member and the output-side rotary member in a rotational direction by a magnetic force of attraction, and has a stiffness that is variable.

Here, the torque inputted to the input-side rotary member is transmitted to the output-side rotary member through the magnetic damper mechanism, and is then outputted therefrom. At this time, the magnetic damper mechanism has the stiffness that is variable. Hence, the stiffness, i.e., damper performance, can be appropriately set in accordance with an operating condition of the vehicle. Because of this, it is possible to realize inhibition of noise and vibration, and simultaneously, realize reduction in damage to be caused by a transient torque with respect to a drive system.

(2) Preferably, the magnetic damper mechanism includes a plurality of input-side magnets provided in the input-side rotary member and a plurality of output-side magnets provided in the output-side rotary member.

Here, the input-side rotary member and the output-side rotary member are magnetically coupled by the plurality of input-side magnets and the plurality of output-side magnets. When relative rotation (displacement) is produced between the input-side rotary member and the output-side rotary member by torque fluctuations or so forth, lines of magnetic force between the plurality of input-side magnets and the plurality of output-side magnets are turned into an unstable condition from a stable condition. Then, the lines of magnetic force are going to restore to the stable condition, whereby a resilient force (a force by which the displacement becomes “0”) acts on the input-side rotary member and the output-side rotary member. Consequently, torque fluctuations are inhibited similarly as done by a damper function exerted by coil springs or so forth.

(3) Preferably, the plurality of input-side magnets and the plurality of output-side magnets are radially opposed to each other, and are axially movable relative to each other.

Here, the plurality of output-side magnets can be axially moved with respect to the plurality of input-side magnets. Because of this, the magnetic damper mechanism can be changed in effective thickness. A resilient force, corresponding to the stiffness, can be changed by changing the effective thickness.

It should be noted that “the effective thickness of the magnetic damper mechanism” refers to the axial length of a region in which the plurality of input-side magnets and the plurality of output-side magnets axially overlap as seen in a direction arranged orthogonally to a rotational axis.

(4) Preferably, the output-side rotary member includes first and second rotary members disposed in axial alignment. Additionally, the plurality of output-side magnets are disposed in outer peripheral parts of the first and second rotary members.

To make the stiffness higher by increasing a coupling force attributed to magnetism, it is herein required to, for instance, increase the size of components (e.g., magnets) of the magnetic damper mechanism. However, the output-side rotary member is herein composed of divided components. Hence, the stiffness can be made higher without increasing the size of components of the magnetic damper mechanism.

(5) Preferably, the first and second rotary members are moved to axially opposite sides.

When the first and second rotary members are herein axially moved, an axial load is generated in each of the first and second rotary members by magnetism. The axial load acts on a part supporting each of the first and second rotary members, whereby an unintended hysteresis torque is generated.

However, the two rotary members are herein moved to the opposite sides. Hence, the axial loads generated in the two rotary members are canceled out. Because of this, the unintended hysteresis torques to be generated by the axial loads can be eliminated.

(6) Preferably, the magnetic damper mechanism is equal in effective thickness between a part thereof including the plurality of output-side magnets disposed in the first rotary member and a part thereof including the plurality of output-side magnets disposed in the second rotary member.

Here, the hysteresis torques can be eliminated by moving the first and second rotary members, each of which include the magnets, to the axially opposite sides by the same amount. Because of this, it is made easy to control movement of the first and second rotary members so as to eliminate the hysteresis torques.

(7) Preferably, the first and second rotary members each include an output-side holder. The output-side holder includes an output-side opposed surface having an annular shape, and holds the plurality of output-side magnets. Additionally, the input-side rotary member includes an input-side holder provided as a single component or a plurality of divided components. The input-side holder includes an input-side opposed surface opposed to the output-side opposed surface, and holds the plurality of input-side magnets. Moreover, the input-side opposed surface and the output-side opposed surface are radially opposed to each other at a predetermined gap.

Here, the output-side magnets are held by the output-side holder. Additionally, the input-side holder and the output-side holder are radially opposed at the opposed surfaces thereof. Therefore, increase in axial space of the present device can be inhibited.

(8) Preferably, the power transmission device further includes a moving mechanism moving the first and second rotary members to the axially opposite sides.

(9) Preferably, the power transmission device further includes an operating information obtaining unit and a controller. The operating information obtaining unit obtains operating information of the vehicle. The controller controls the stiffness of the magnetic damper mechanism by actuating the moving mechanism in accordance with the operating information transmitted thereto from the operating information obtaining unit.

Here, the operating information (e.g., a rotational speed of the drive source, an accelerator opening degree, etc.) is obtained, and the stiffness of the magnetic damper mechanism is controlled in accordance with the obtained operating information. Because of this, an appropriate damper characteristic can be obtained in accordance with the operating information.

Overall, according to the present invention described above, it is possible in the power transmission device to obtain a damper characteristic capable of realizing inhibition of noise and vibration in occurrence of a high-order resonance point, and simultaneously, realizing reduction in damage to be caused by a transient torque with respect to a drive system.

### BRIEF DESCRIPTION OF THE DRAWINGS

FIG. 1 is a cross-sectional configuration view of a power transmission device according to a preferred embodiment of the present invention.

FIG. 2 is a partial front view of an input-side rotary member, an output-side rotary member and a magnetic damper mechanism in the power transmission device shown in FIG. 1.

FIG. 3 is a partial enlarged view of FIG. 1.

FIG. 4 is a partial enlarged view of FIG. 1 and shows a part different from the part shown in FIG. 3.

FIG. 5 is a diagram showing a magnetic field where a torsion angle of the magnetic damper mechanism is 0 degrees.

FIG. 6 is a diagram showing a magnetic field where the torsion angle of the magnetic damper mechanism is 10 degrees.

FIG. 7 is a torsional characteristic diagram of the preferred embodiment shown in FIG. 1.

FIG. 8 is a control block diagram of the power transmission device.

FIG. 9 is a control flowchart of the power transmission device.

FIG. 10 is a diagram showing a relation between rotational speed and fluctuations in rotation where a stiffness of the magnetic damper mechanism is made variable.

FIG. 11 is a diagram showing a relation between elapse of time since pressing down an accelerator and forward/backward gravitational acceleration of a vehicle.

FIG. 12 is a schematic diagram of a power transmission device according to another preferred embodiment of the present invention.

### DETAILED DESCRIPTION

### [Entire Configuration]

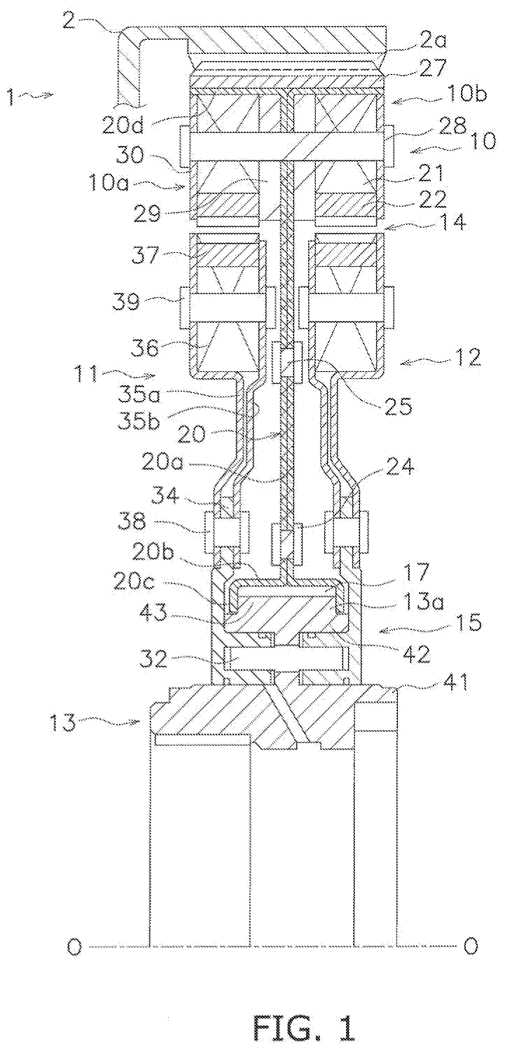

FIG. 1 is a cross-sectional view of a power transmission device 1 according to a preferred embodiment of the present invention. In FIG. 1, line O-O indicates a rotational axis. The power transmission device 1 is a device for transmitting a torque, inputted thereto from a drive member 2 coupled to a drive source, to an input shaft (not shown in the drawings) of a transmission. The power transmission device 1 includes an input-side rotary member 10, a pair of a first output-side rotary member 11 (exemplary first rotary member) and a second output-side rotary member 12 (exemplary second rotary member), an output hub 13, a magnetic damper mechanism 14 and a moving mechanism 15.

### [Input-Side Rotary Member 10]

The input-side rotary member 10 is supported by the output hub 13 through a bearing 17, while being rotatable and axially immovable. The input-side rotary member 10 includes a pair of input units 10a and 10b having the same configuration. Each input unit 10a, 10b includes a support plate 20, an input-side holder 21 and a plurality of input-side magnets 22. These input units 10a and 10b are disposed to be axially symmetric to each other.

The support plate 20 includes a body 20a having a disc shape, an inner peripheral side tubular portion 20b, a stopper portion 20c and an outer peripheral side tubular portion 20d.

In a pair of support plates 20, the bodies 20a are disposed axially between the first and second output-side rotary members 11 and 12. The bodies 20a extend to the further outer peripheral side than the first and second output-side rotary members 11 and 12. The bodies 20a are fixed to each other at inner peripheral parts thereof by at least one rivet 24, while being fixed to each other at radially intermediate parts thereof by at least one rivet 25. In other words, the pair of input units 10a and 10b are fixed to each other by the rivets 24 and 25, while being axially immovable and non-rotatable relative to each other.

In the pair of support plates 20, the inner peripheral side tubular portions 20b axially extend from the inner peripheral ends of the bodies 20a so as to separate from each other. Here, the output hub 13 is provided with a support portion 13a, protruding to the outer peripheral side, on the outer peripheral surface thereof. Additionally, the aforementioned bearing 17 is disposed between the inner peripheral side tubular portions 20b and the outer peripheral surface of the support portion 13a of the output hub 13. The stopper portions 20c are formed by bending the distal ends of the inner peripheral side tubular portions 20b to the inner peripheral side. The stopper portions 20c are shaped to axially interpose the support portion 13a of the output hub 13 therebetween.

With the aforementioned inner peripheral side tubular portions 20b and stopper portions 20c, the input-side rotary member 10 is supported by the output hub 13, while being axially immovable and rotatable relative thereto.

In the pair of support plates 20, the outer peripheral side tubular portions 20d axially extend from the outer peripheral ends of the bodies 20a so as to separate from each other. The input-side holders 21 are disposed on the inner peripheral side of the outer peripheral side tubular portions 20d. Additionally, a ring gear 27, including a plurality of teeth on the outer peripheral surface thereof, is fixed to the outer peripheral surfaces of the outer peripheral side tubular portions 20d. The ring gear 27 is meshed with a plurality of teeth 2a provided on a drive source-side part of the inner peripheral surface of the drive member 2. Therefore, the torque, transmitted from the drive source, is inputted to the input-side rotary member 10 through meshing of these teeth.

The input-side holders 21 are formed by axially laminating annular plates made of soft magnetic material such as iron. The input-side holders 21 are disposed to make contact with the inner peripheral surfaces of the outer peripheral side tubular portions 20d. Additionally, the input-side holders 21 are fixed to the pair of support plates 20 by a plurality of rivets 28 penetrating the input-side holders 21 and the pair of support plates 20.

It should be noted that spacers 29 are each disposed between the body 20a of each support plate 20 and each input-side holder 21. Additionally, cover plates 30, having an annular shape, are each disposed on the axially outer surface of each input-side holder 21. These spacers 29 and cover plates 30 are made of non-magnetic material such as aluminum, and are fixed together with the input-side holders 21 to the pair of support plates 20 by the rivets 28.

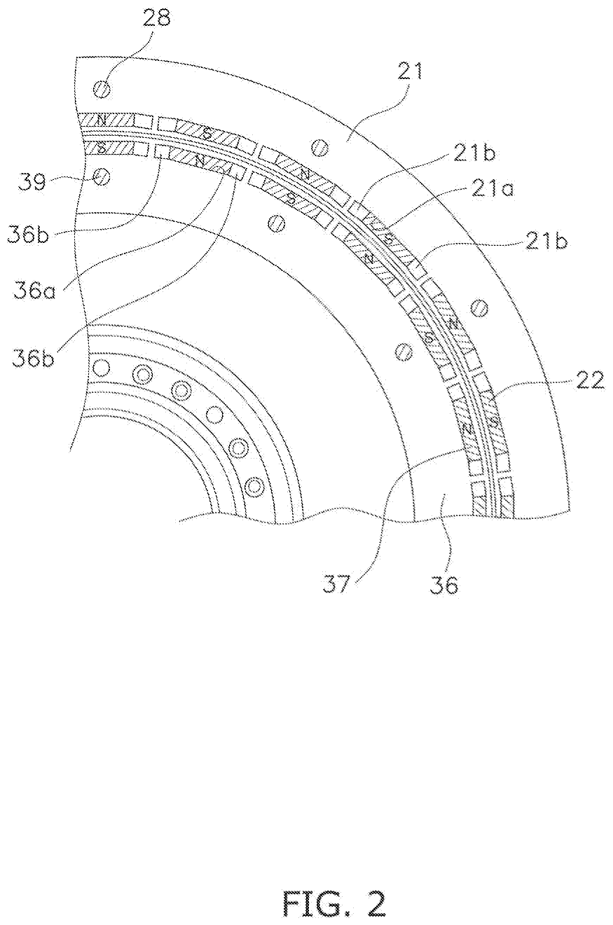

Additionally, as shown in FIG. 2, the input-side holder 21 is provided with a plurality of accommodation portions 21a and a plurality of flux barriers 21b on the inner peripheral side of the rivets 28.

Each accommodation portion 21a is an opening that has a rectangular shape as seen in a front view, and has a predetermined thickness in a radial direction. Additionally, each accommodation portion 21a axially penetrates the input-side holder 21. One pair of flux barriers 21b is provided on the both circumferential ends of each accommodation portion 21a. One pair of flux barriers 21b is one pair of openings axially penetrating the input-side holder 21. In other words, one pair of flux barriers 21b is herein one pair of gaps. It should be noted that non-magnetic material such as resin can be attached, as one pair of flux barriers 21b, to each accommodation portion 21a. One pair of flux barriers 21b is shaped continuously to each accommodation portion 21a, and each is shaped to slant radially inward with separation from the boundary thereof against each accommodation portion 21a.

### [First and Second Output-Side Rotary Members 11 and 12]

The first and second output-side rotary members 11 and 12 are coupled to the output hub 13 by pins 32. In more detail, the first and second output-side rotary members 11 and 12 are coupled to the output hub 13 by the pins 32, while being axially movable with respect thereto and non-rotatable relative thereto. The input-side rotary member 10 is herein rotatable relative to the output hub 13, and therefore, the input-side rotary member 10 and the first and second output-side rotary members 11 and 12 are rotatable relative to each other.

The first and second output-side rotary members 11 and 12 are shaped to be axially symmetric to each other, and the constituent elements of the both members 11 and 12 are the same as each other.

Each of the first and second output-side rotary members 11 and 12 includes a flange 34, a pair of support plates 35a and 35b, an output-side holder 36 and a plurality of output-side magnets 37.

The flange 34 has a disc shape, and is supported by the output hub 13 while being axially movable. The pair of support plates 35a and 35b, each having a substantially disc shape, is fixed at the inner peripheral part thereof to the outer peripheral part of the flange 34 by at least one rivet 38. The pair of support plates 35a and 35b is made of non-magnetic material such as aluminum. The pair of support plates 35a and 35b is processed with bending so as to axially separate from each other at the outer peripheral parts thereof.

The output-side holder 36 is accommodated in the outer peripheral parts of the pair of support plates 35a and 35b. In other words, the output-side holder 36 is disposed to be axially interposed by the outer peripheral parts of the pair of support plates 35a and 35b. The output-side holder 36 is formed by axially laminating annular plates made of soft magnetic material such as iron. Additionally, rivets 39 are provided to axially penetrate the pair of support plates 35a and 35b and the output-side holder 36. The output-side holder 36 is fixed to the pair of support plates 35a and 35b by the rivets 39.

Moreover, the output-side holder 36 is disposed on the inner peripheral side of the input-side holder 21, while being opposed thereto. Besides, a predetermined gap is produced between the outer peripheral surface (exemplary output-side opposed surface) of the output-side holder 36 and the inner peripheral surface (exemplary input-side opposed surface) of the input-side holder 21.

Furthermore, as shown in FIG. 2, the output-side holder 36 is provided with a plurality of accommodation portions 36a and a plurality of flux barriers 36b on the outer peripheral side of the rivets 39. It should be noted that FIG. 2 only shows the output-side holder 36, the input-side holder 21 and magnets accommodated in the holders 36 and 21, while the other members are removed therefrom.

Each accommodation portion 36a is an opening that has a rectangular shape as seen in a front view, and has a predetermined thickness in a radial direction. Additionally, each accommodation portion 36a axially penetrates the output-side holder 36. Also, the plural accommodation portions 36a are disposed in circular alignment, while being radially opposed to the corresponding accommodation portions 21a of the input-side holder 21. One pair of flux barriers 36b is provided on the both circumferential ends of each accommodation portion 36a. It should be noted that each accommodation portion 36a and one pair of flux barriers 36b are continuously shaped as a single opening axially penetrating the output-side holder 36. In other words, one pair of flux barriers 36b is herein one pair of gaps. It should be noted that non-magnetic material such as resin can be attached, as one pair of flux barriers 36b, to each accommodation portion 36a.

### [Output Hub 13]

The output hub 13 is coupled to, for instance, the input shaft of the transmission. The output hub 13 includes a hub body 41 having an annular shape, a cylinder portion 42 provided in the outer peripheral part of the hub body 41, and a support portion 43 having an annular shape. The support portion 43 is provided on the outer peripheral surface of the cylinder portion 42, and protrudes to the outer peripheral side. A range, in which the support portion 43 is provided, has a shorter axial length than the cylinder portion 42. Additionally, the stopper portions 20c of the support plates 20 of the input-side rotary member 10 are capable of making contact with the both lateral surfaces of the support portion 43.

### [Magnetic Damper Mechanism 14]

The magnetic damper mechanism 14 magnetically couples the input-side rotary member 10 and the first and second output-side rotary members 11 and 12, and attenuates torsional vibration inputted thereto by variable stiffness (torsional characteristic). The expression “magnetically coupling the input-side rotary member 10 and the first and second output-side rotary members 11 and 12” means, as described above, coupling the both in the rotational direction by magnetism.

The magnetic damper mechanism 14 is composed of the plural input-side magnets 22 provided in the input-side rotary member 10 and the plural output-side magnets 37 provided in the first and second output-side rotary members 11 and 12.

The plural input-side magnets 22 are disposed in the accommodation portions 21a of the input-side holders 21, respectively. On the other hand, the plural output-side magnets 37 are disposed in the accommodation portions 36a of the output-side holders 36, respectively. Therefore, the input-side magnets 22 and the output-side magnets 37 are disposed in radial opposition to each other. Moreover, the axial length of each input-side magnet 22 and that of each output-side magnet 37 are equal.

The input-side magnets 22 and the output-side magnets 37 are permanent magnets formed by neodymium sintered magnets or so forth. As shown in FIG. 2, each opposed pair of the input-side magnet 22 and the output-side magnet 37 is disposed to have opposite polarities N and S whereby a pull force (force of attraction) is generated therebetween. Additionally, the plural input-side magnets 22 are disposed such that the polarities N and S are alternately disposed in circumferential alignment. This configuration is also true of the plural output-side magnets 37.

### [Moving Mechanism 15]

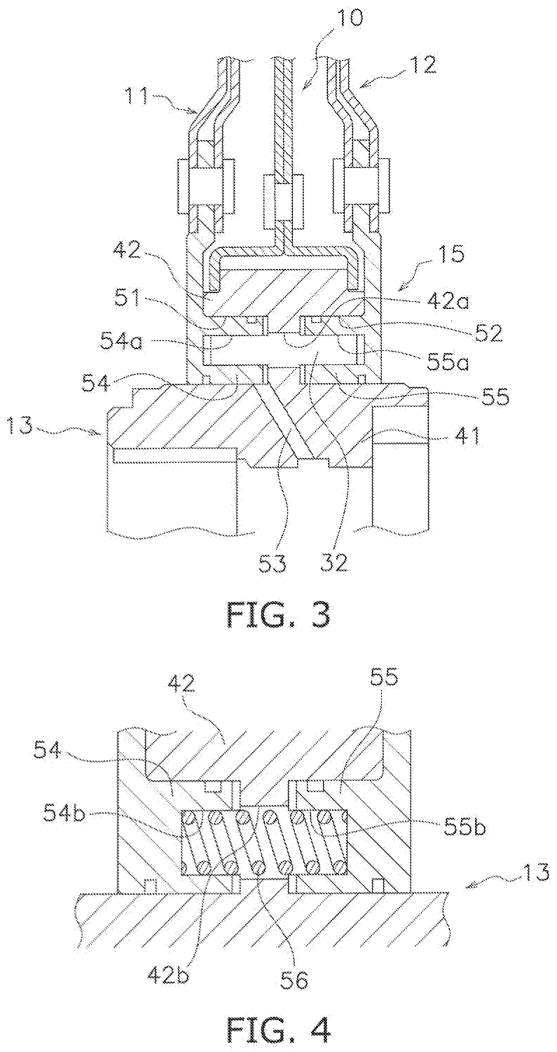

The moving mechanism 15 is provided in the cylinder portion 42 of the output hub 13 and the inner peripheral parts of the first and second output-side rotary members 11 and 12. The moving mechanism 15 moves the first and second output-side rotary members 11 and 12 to axially opposite sides by hydraulic pressure. As shown close-up in FIGS. 3 and 4, the moving mechanism 15 includes first and second cylinders 51 and 52, an oil pathway 53, first and second pistons 54 and 55, and a plurality of coil springs 56. It should be noted that FIG. 4 is a partial view of a site located in a different circumferential position from a site shown in FIG. 3.

The first cylinder 51 is an annular groove provided in the cylinder portion 42, and axially extends while being opened to a first axial side (left side in FIG. 1). The second cylinder 52 is an annular groove provided in the cylinder portion 42, and is provided in axial opposition to the first cylinder 51. The second cylinder 52 axially extends while being opened to a second axial side (right side in FIG. 1). Additionally, the second cylinder 52 communicates with the first cylinder 51 on the first axial side.

The oil pathway 53 is provided in the hub body 41 of the output hub 13, while radially penetrating therethrough. In more detail, the oil pathway 53 is provided from the inner peripheral surface of the hub body 41 to the interior of the first cylinder 51 so as to make the both communicate therethrough. Hydraulic oil is supplied to the first cylinder 51 through the oil pathway 53, and is further supplied from the first cylinder 51 to the second cylinder 52.

The first piston 54 is an annular protrusion shaped to axially extend from the inner peripheral part of the first output-side rotary member 11. The first piston 54 is inserted into the first cylinder 51, while being movable therein. The second piston 55 is an annular protrusion shaped to axially extend from the inner peripheral part of the second output-side rotary member 12. The second piston 55 is inserted into the second cylinder 52, while being movable therein. Additionally, each piston 54, 55 is provided with seal members on the inner and outer peripheral surfaces thereof.

Each piston 54, 55 is provided with a plurality of pin holes 54a, 55a and a plurality of spring holes 54b, 55b. The pin holes 54a, 55a and the spring holes 54b, 55b are each shaped to axially extend from the distal end of each piston 54, 55 at a predetermined depth. In other words, the pin holes 54a and 55a and the spring holes 54b and 55b are closed-end holes. On the other hand, the output hub 13 is provided with a plurality of pin through holes 42a and a plurality of spring through holes 42b in the cylinder portion 42 so as to make the first and second cylinders 51 and 52 communicate therethrough.

The pins 32 are provided to penetrate the pin through holes 42a of the cylinder portion 42, respectively. Additionally, each pin 32 is inserted at one end thereof into each pin hole 54a of the first piston 54, while being inserted at the other end into each pin hole 55a of the second piston 55. The first and second pistons 54 and 55, i.e., the first and second output-side rotary members 11 and 12 are coupled to each other by the pins 32, while being axially movable and non-rotatable relative to each other.

The coil springs 56 are provided to penetrate the spring through holes 42b of the cylinder portion 42, respectively. Additionally, each coil spring 56 is inserted at one end thereof into each spring hole 54b of the first piston 54, while being inserted at the other end thereof into each spring hole 55b of the second piston 55. Each coil spring 56 is set in a compressed state, while the first and second output-side rotary members 11 and 12 are not being axially moved as shown in FIGS. 1 and 3. In other words, the first and second output-side rotary members 11 and 12 receive, from the coil springs 56, preloads directed to axially separate the both from each other.

### [Actuation of Magnetic Damper Mechanism 14]

In the present preferred embodiment, a torque is inputted to the input-side rotary member 10 from the drive source such as an engine (not shown in the drawings) through the drive member 2.

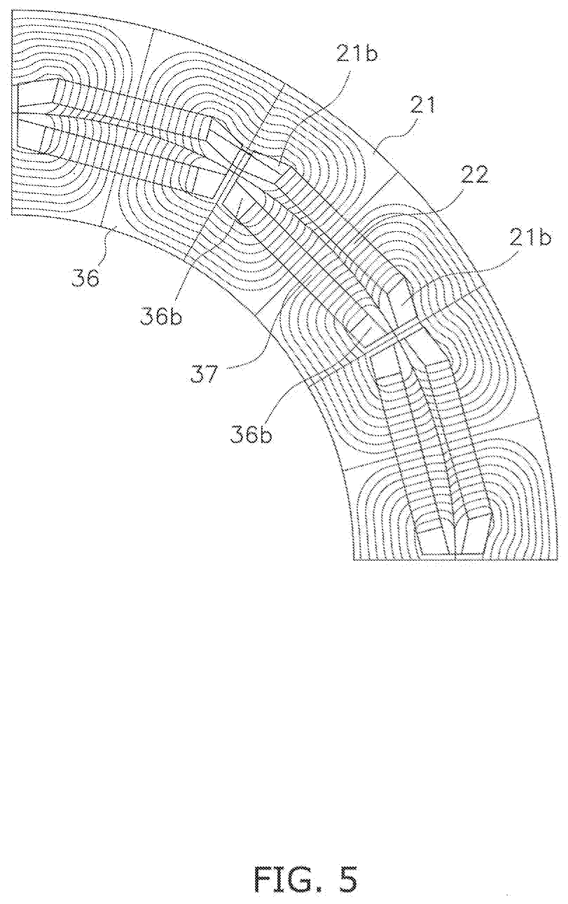

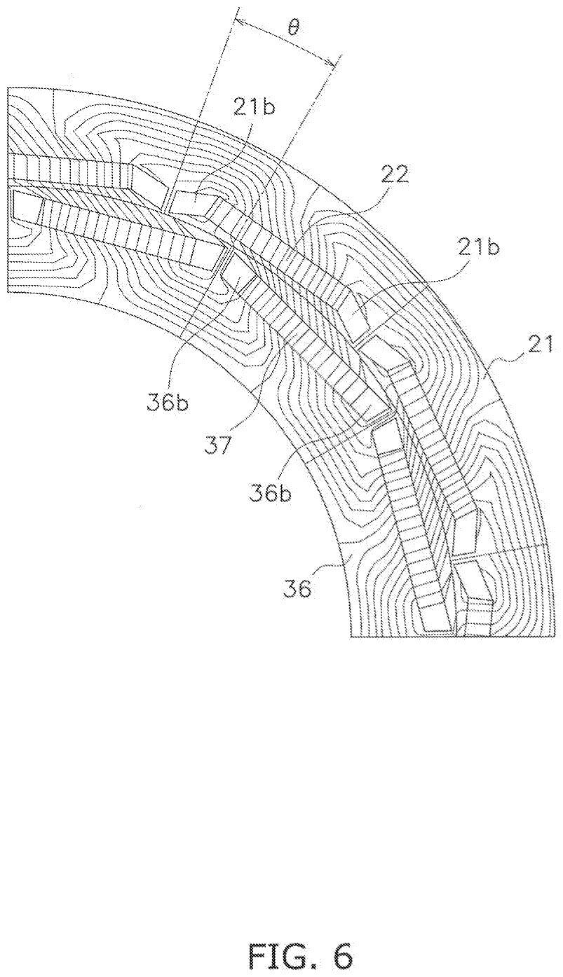

FIGS. 5 and 6 are magnetic field diagrams showing lines of magnetic force between the input-side magnets 22 and the output-side magnets 37. It should be noted that in FIGS. 5 and 6, radially extending straight lines are depicted between circumferentially adjacent two of the input-side magnets 22 and between circumferentially adjacent two of the output-side magnets 37 for convenience and easy understanding of a rotational phase difference between each input-side holder 21 and each output-side holder 36 and a condition of lines of magnetic force. Hence, the radially extending straight lines are not depicted as lines of magnetic force. Additionally, circumferential division of each holder 21, 36 is not indicated by the radially extending straight lines.

When torque fluctuations do not exist in torque transmission, the input-side rotary member 10 and the both output-side rotary members 11 and 12 are rotated in the condition shown in FIG. 5. In other words, the input-side rotary member 10 and the both output-side rotary members 11 and 12 are rotated without relative displacement in the rotational direction (i.e., in a condition that the rotational phase difference is “0”), because the input-side rotary member 10 and the both output-side rotary members 11 and 12 are magnetically coupled by the pull forces (forces of attraction) of the input-side magnets 22 and the output-side magnets 37 provided in the respective holders 21 and 36.

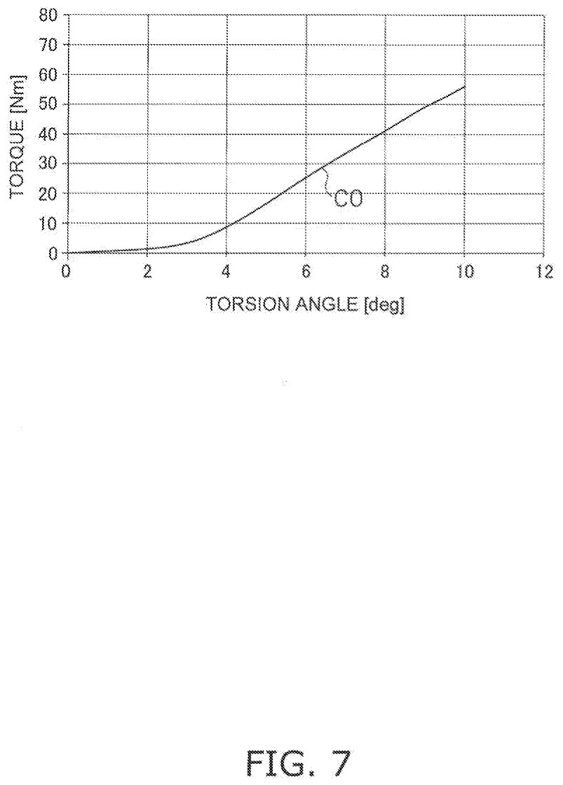

In such a condition that the input-side magnets 22 with the polarity N and the output-side magnets 37 with the polarity S are opposed without being displaced in the rotational direction, lines of magnetic force generated by the input-side magnets 22 and the output-side magnets 37 are in the most stable condition. This condition corresponds to the origin (where torsion angle is 0 degrees) in the torsional characteristic diagram of FIG. 7.

On the other hand, when torque fluctuations exist in torque transmission, a rotational phase difference θ (of 10 degrees in this example) is produced between the input-side rotary member 10 and the both output-side rotary members 11 and 12 as shown in FIG. 6. In this condition, lines of magnetic force generated by the input-side magnets 22 and the output-side magnets 37 are distorted, and are changed into an unstable condition. The lines of magnetic force changed into the unstable condition are going to restore to the stable condition as shown in FIG. 5, whereby a resilient force is generated. In other words, the resilient force is generated to make the displacement (rotational phase difference) between the input-side rotary member 10 and the both output-side rotary members 11 and 12 “0”. The resilient force corresponds to an elastic force in a heretofore known damper mechanism using torsion springs.

As described above, when the rotational phase difference is produced between the input-side rotary member 10 and the both output-side rotary members 11 and 12 by torque fluctuations, the input-side rotary member 10 and the both output-side rotary members 11 and 12 receive the resilient force that is attributed to the input-side magnets 22 and the output-side magnets 37 and is directed to reduce the rotational phase difference therebetween. Torque fluctuations are inhibited by this force.

The aforementioned force for inhibiting torque fluctuations is changed in accordance with the rotational phase difference between the input-side rotary member 10 and the output-side rotary members 11 and 12, whereby torsional characteristic C0 can be obtained as shown in FIG. 7.

### [Actuation of Moving Mechanism 15]

When the hydraulic oil is introduced to the respective cylinders 51 and 52 through the oil pathway 53, the pistons 54 and 55 corresponding thereto are actuated. Accordingly, the first output-side rotary member 11 is moved to the first axial side, whereas the second output-side rotary member 12 is moved to the second axial side. At this time, the first and second output-side rotary members 11 and 12 are moved by the same amount. In other words, the first and second output-side rotary members 11 and 12 are moved to the axially opposite sides by the same amount.

When each output-side rotary member 11, 12 is thus axially moved, the magnetic damper mechanism 14 can be reduced in effective thickness (that refers to, as described above, the axial length of a region in which the input-side magnets 22 and the output-side magnets 37 axially overlap as seen in a direction arranged orthogonally to the rotational axis). With reduction in effective thickness, it is possible to reduce the magnetic coupling force between the input-side rotary member 10 and the both output-side rotary members 11 and 12, i.e., the elastic force (resilient force). Therefore, the magnetic damper mechanism 14 can be reduced in torsional stiffness. Specifically, the slope of the characteristic shown in FIG. 7 can be made as gentle as possible.

When the output-side rotary members 11 and 12 are herein axially moved, an axial load acts on the input-side rotary member 10 and each output-side rotary member 11, 12. This axial load acts on a part such as a bearing supporting the respective members, whereby an unintended hysteresis torque is generated.

However, in the present preferred embodiment, the first and second output-side rotary members 11 and 12 are moved to the opposite sides by the same distance. Therefore, the axial loads to be generated by movement of these output-side rotary members 11 and 12 are canceled out. Because of this, the hysteresis torque to be generated by movement and rotation of each output-side rotary member 11, 12 can be eliminated.

### [Driving of Moving Mechanism 15 and Control Flowchart]

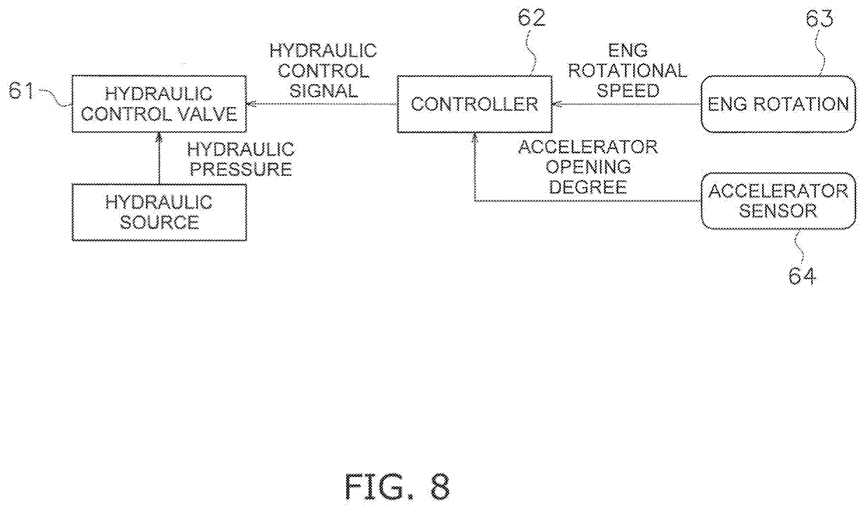

FIG. 8 shows a control block diagram for driving the moving mechanism 15. A hydraulic control valve 61, provided as a drive mechanism, is connected to the moving mechanism 15. Hydraulic pressure is supplied to the hydraulic control valve 61 from a hydraulic source such as an oil pump. Additionally, the hydraulic control valve 61 is controlled by a hydraulic control signal transmitted thereto from a controller 62, whereby the hydraulic pressure is controlled by the hydraulic control valve 61 and is supplied to the oil pathway 53 of the moving mechanism 15.

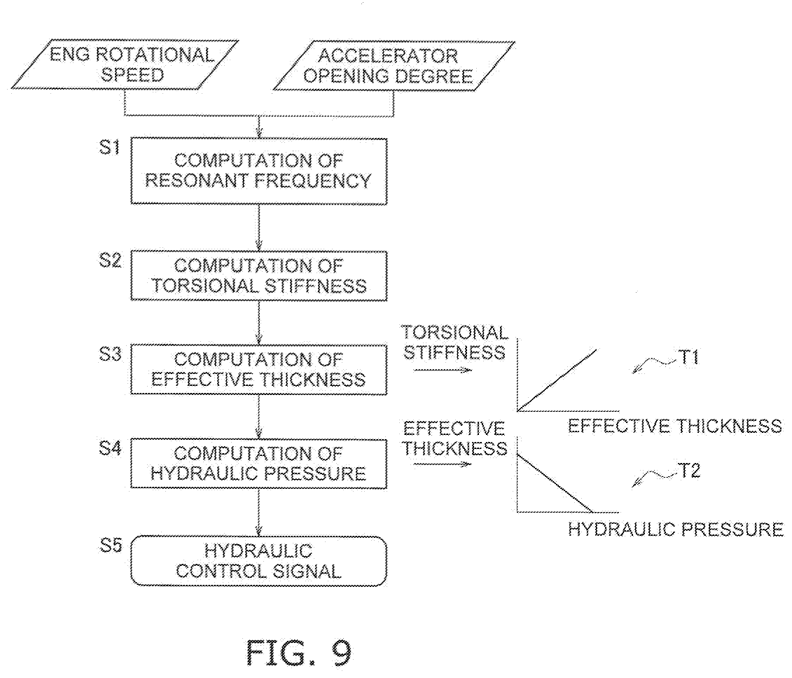

The controller 62 receives, as control parameters, engine rotational speed inputted thereto from an engine rotational speed sensor 63 and accelerator opening degree (in which an acceleration in pressing down an accelerator can be included on an as-needed basis) inputted thereto from an accelerator sensor 64. Then, by following a flowchart shown in FIG. 9, the controller 62 computes a hydraulic control signal based on the aforementioned control parameters, and outputs the hydraulic control signal to the hydraulic control valve 61.

First in steps S1 and S2, in receipt of information from the engine rotational speed sensor 63 and the accelerator sensor 64, resonance frequency and torsional stiffness optical to an operating condition at this point of time are computed based on the information. The optimal torsional stiffness can be obtained by computation, or alternatively, can be obtained with a preliminarily created map.

Next in step S3, as shown in FIG. 9, with reference to preliminarily obtained table T1 showing a relation between effective thickness and torsional stiffness, effective thickness is computed based on the torsional stiffness obtained in step S2.

Furthermore in step S4, with reference to preliminarily obtained table T2 showing a relation between hydraulic pressure and effective thickness, hydraulic pressure is computed based on the effective thickness obtained in step S3. Then in step S5, a hydraulic control signal is computed. The hydraulic control valve 61 is controlled by the hydraulic control signal.

As described above, with the moving mechanism 15, the effective thickness of the magnetic damper mechanism 14 can be changed, and the torsional stiffness of the dynamic damper device 14 can be set to an arbitrary characteristic.

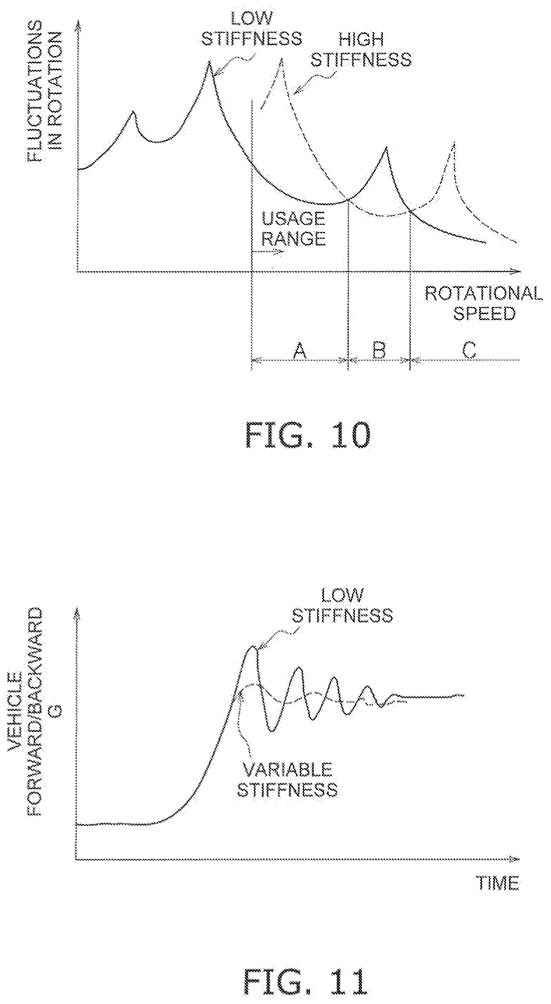

FIG. 10 shows a relation between rotational speed and fluctuations in rotation on the output side where the stiffness of the magnetic damper mechanism 14 is made variable. In this example, solid line indicates a characteristic where the stiffness of the magnetic damper mechanism 14 is set to low, whereas broken line indicates a characteristic where the stiffness of the magnetic damper mechanism 14 is set to high. Here, fluctuations in rotation can be inhibited over the entire range of the rotational speed by controlling the stiffness of the magnetic damper mechanism 14 to low in a rotational speed range A, high in a rotational speed range B and low in a rotational speed range C.

On the other hand, FIG. 11 shows a relation between elapse of time since pressing down an accelerator and forward/backward gravitational acceleration of a vehicle. In FIG. 11, solid line indicates a characteristic of a damper mechanism having a torsional characteristic with constant low stiffness, whereas broken line indicates a characteristic of the magnetic damper mechanism of the present preferred embodiment having a torsional characteristic with variable stiffness. As shown in FIG. 11, shock can be inhibited by making the torsional characteristic variable.

### [Other Preferred Embodiments]

The present invention is not limited to the preferred embodiment described above, and a variety of changes or modifications can be made without departing from the scope of the present invention.

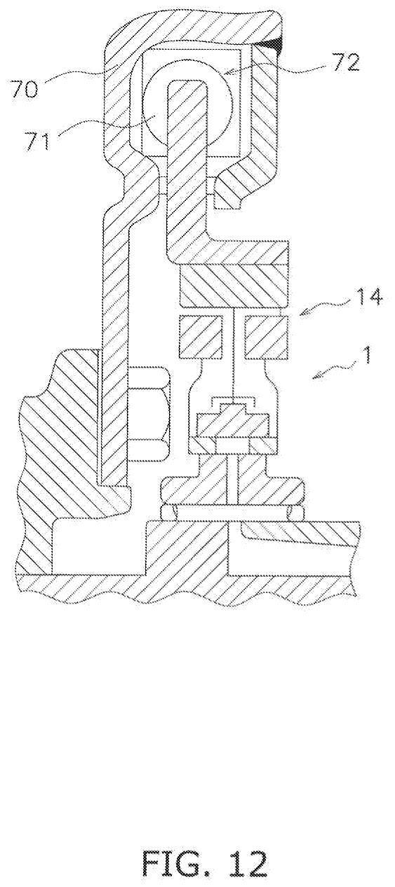

(a) FIG. 12 is a schematic diagram of another preferred embodiment in which a damper mechanism using heretofore known coil springs is provided in addition to the constituent elements of the power transmission device 1 shown in FIG. 1. In short, in this preferred embodiment, a damper mechanism 72, including a plurality of coil springs 71, is provided between a drive member 70 coupled to the drive source and the power transmission device 1 including the magnetic damper mechanism 14 shown in FIG. 1.

(b) In the aforementioned preferred embodiment, the output-side magnets are disposed in opposition to the input-side magnets on a one-to-one basis. However, one of each pair of output-side and input-side magnets can be divided.

Furthermore, each input-side magnet can be divided, and likewise, each output-side magnet can be divided. The divided parts of each input-side magnet can be disposed in opposition to those of each output-side magnet.

(c) In the aforementioned preferred embodiment, the input-side rotary member 10 is composed of two holders divided from each other, but alternatively, can be composed of a single holder. Likewise, the input-side magnets are composed of two groups of magnets divided from each other, but alternatively, can be composed of a single group of magnets.

(d) In the aforementioned preferred embodiment, the output-side rotary member is composed of two parts divided from each other. Alternatively, the input-side rotary member can be divided into two parts, and the divided parts can be configured to be axially movable.

(e) In the aforementioned preferred embodiment, the moving mechanism is configured to move the two output-side rotary members to the axially opposite sides by the same amount. However, the configuration of the moving mechanism is not limited to this. For example, the moving mechanism can be configured to move the two output-side rotary members independently from each other in arbitrary directions.

### REFERENCE SIGNS LIST

1 Power transmission device
10 Input-side rotary member
11, 12 Output-side rotary member
14 Magnetic damper mechanism
15 Moving mechanism
21 Input-side holder
22 Input-side magnet
36 Output-side holder
37 Output-side magnet
62 Controller
63 Engine rotational speed sensor
64 Accelerator sensor

What is claimed is:

1. A power transmission device disposed in a path from a drive source to a wheel in a vehicle, the power transmission device comprising:
an input-side rotary member to which a torque is inputted from the drive source;
an output-side rotary member disposed to be rotatable relative to the input-side rotary member; and
a magnetic damper mechanism configured to elastically couple the input-side rotary member and the output-side rotary member in a rotational direction by a magnetic force of attraction, the magnetic damper mechanism having a variable stiffness.

2. The power transmission device according to claim 1, wherein the magnetic damper mechanism includes
a plurality of input-side magnets provided in the input-side rotary member, and
a plurality of output-side magnets provided in the output-side rotary member.

3. The power transmission device according to claim 2, wherein
the plurality of input-side magnets and the plurality of output-side magnets are radially opposed to each other, and
the plurality of input-side magnets and the plurality of output-side magnets are axially movable relative to each other.

4. The power transmission device according to claim 3, wherein
the output-side rotary member includes first and second rotary members disposed in axial alignment, and
the plurality of output-side magnets are disposed in outer peripheral parts of the first and second rotary members.

5. The power transmission device according to claim 4, wherein the first and second rotary members are moved to axially opposite sides.

6. The power transmission device according to claim 5, wherein the magnetic damper mechanism is equal in effective thickness between a part thereof including the plurality of output-side magnets disposed in the first rotary member and a part thereof including the plurality of output-side magnets disposed in the second rotary member.

7. The power transmission device according to claim 4, wherein
the first and second rotary members each include an output-side holder, the output-side holder including an output-side opposed surface having an annular shape, the output-side holder configured to hold the plurality of output-side magnets,
the input-side rotary member includes an input-side holder provided as a single component or a plurality of divided components, the input-side holder including an input-side opposed surface opposed to the output-side opposed surface, the input-side holder configured to hold the plurality of input-side magnets, and
the input-side opposed surface and the output-side opposed surface are radially opposed to each other at a predetermined gap.

8. The power transmission device according to claim 4, further comprising:
a moving mechanism configured to move the first and second rotary members to axially opposite sides.

9. The power transmission device according to claim 8, further comprising:
an operating information obtaining unit configured to obtain operating information of the vehicle; and
a controller configured to control the stiffness of the magnetic damper mechanism by actuating the moving mechanism in accordance with the operating information transmitted thereto from the operating information obtaining unit.
